(19) United States
(12) Patent Application Publication
(10) Pub. No.: US 2013/0107511 A1
(43) Pub. Date: May 2, 2013

(54) LED ILLUMINATION MODULE

(71) Applicants: CHIA-CHIANG YANG, Hukou (TW); WEN-LIANG TSENG, Hukou (TW)

(72) Inventors: CHIA-CHIANG YANG, Hukou (TW); WEN-LIANG TSENG, Hukou (TW)

(73) Assignee: ADVANCED OPTOELECTRONIC TECHNOLOGY, INC., Hsinchu Hsien (TW)

(21) Appl. No.: 13/492,926

(22) Filed: Jun. 11, 2012

(30) Foreign Application Priority Data
Oct. 31, 2011 (CN) 201110337343.3

(51) Int. Cl. F21V 13/08; F21V 9/00

(52) U.S. Cl. 362/230

(57) ABSTRACT

An LED illumination module includes a base, first white-light LEDs mounted on a central portion of a top surface of the base, and second white-light LEDs mounted on a periphery of the top surface of the base and surrounding the first white-light LEDs. A power of the first white-light LEDs is equal to that of the second white-light LEDs. An average value of luminescence efficiencies of the first white-light LEDs is smaller than that of the second white-light LEDs. An average value of color rendering indexes of the first white-light LEDs is larger than that of the second white-light LEDs.

### BACKGROUND

1. Technical Field

The disclosure generally relates to an LED (light emitting diode) module, and particularly to an LED illumination module having a balanced illumination intensity at a central portion and a periphery thereof thereby to obtain an even illumination.

2. Description of Related Art

LEDs as solid-state illuminating apparatuses, are being widely used in the illumination filed to substitute for conventional fluorescent lamps due to their high brightness, long service lifetime, and wide color gamut.

A conventional LED illumination module includes a base and a plurality of LEDs mounted on the base. In use, a part of light emitted from the LEDs mounted on a periphery of the base is directed to a central portion of the LED illumination module and is combined with light emitted from the LEDs mounted on the central portion of the base. Thus, an illumination intensity of the central portion of the LED illumination module is stronger than that of the periphery of the LED illumination module. Therefore, a discomfort glare will be produced.

What is needed, therefore, is an improved LED illumination module to overcome the above described shortcomings

### BRIEF DESCRIPTION OF THE DRAWINGS

FIG. 1 is a top view of an LED illumination module according to a first embodiment of the present disclosure.

FIG. 2 is a top view of an LED illumination module according to a second embodiment of the present disclosure.

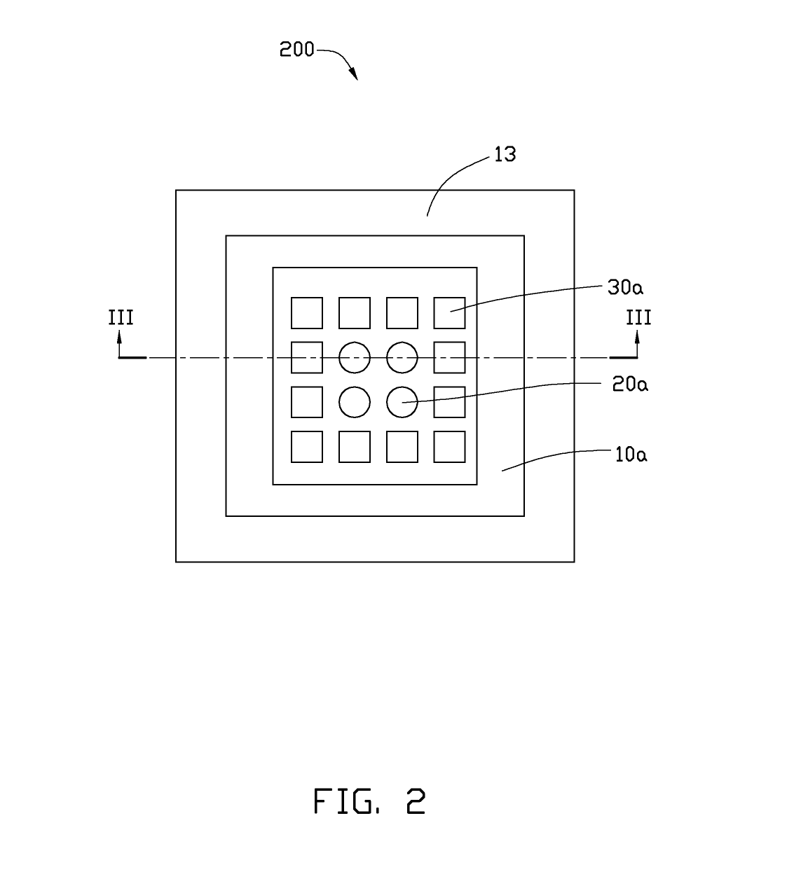

FIG. 3 is a cross-sectional view of the LED illumination module of FIG. 2, taken along line III-III thereof.

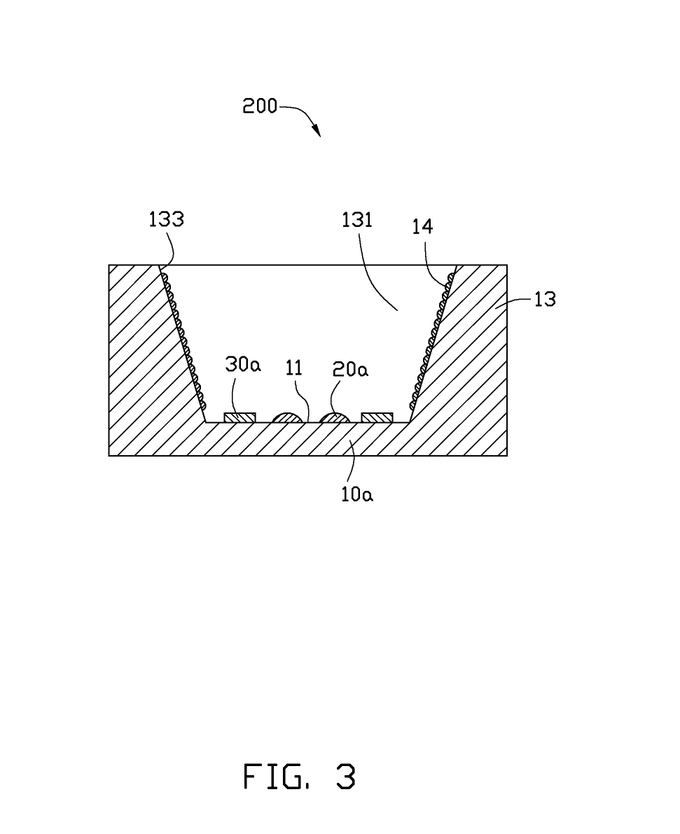

### DETAILED DESCRIPTION

Embodiments of LED illumination module will now be described in detail below and with reference to the drawings.

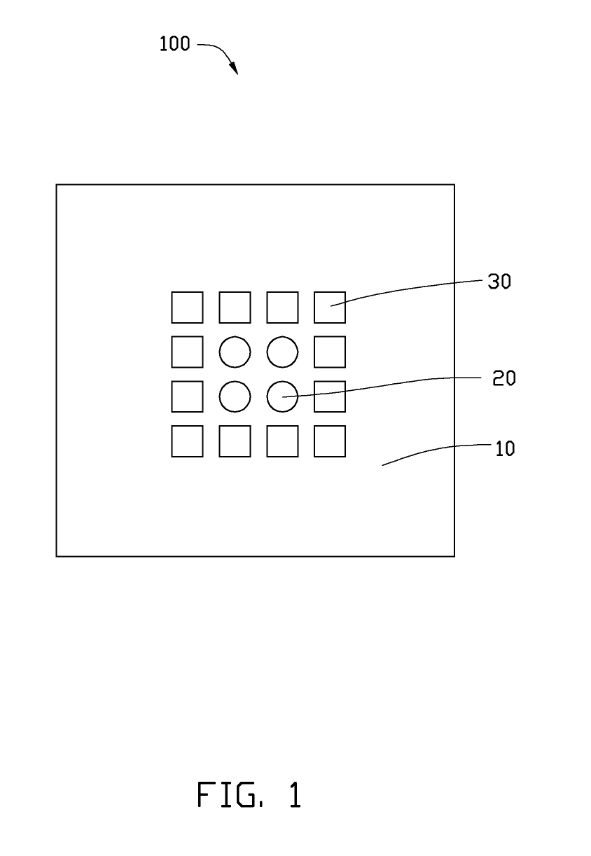

Referring to FIG. 1, an LED illumination module 100 in accordance with a first embodiment of the present disclosure includes a rectangular base 10, a plurality of first white-light LEDs 20 and a plurality of second white-light LEDs 30. The first white-light LEDs 20 are spaced from each other and mounted on a central portion of a top surface of the base 10. The second white-light LEDs 30 are spaced from each other and mounted on a periphery of the top surface of the base 10. The second white-light LEDs 30 surround the first white-light LEDs 20.

Each first white-light LED 20 includes a blue chip (not shown) and a plurality phosphor particles (not shown) surrounding the blue chip. The phosphor particles include red phosphor particles and green phosphor particles mixed together. The red and green phosphor particles can be excited by blue light from the blue chip to emit yellow light. A first white light can be formed by a mixture of the yellow light and the residuary blue light.

Each second white-light LED 30 includes a blue chip (not shown) and a plurality of yellow phosphor particles (not shown) surrounding the blue chip. The yellow phosphor particles can be excited by blue light from the blue chip to emit yellow light, and a second white light can be formed by a mixture of the yellow light and the residuary blue light from the blue chip of the second white-light LED 30.

An average value of luminescence efficiencies of the first white-light LEDs 20 is V1. An average value of color rendering indexes of the first white-light LEDs 20 is C1. An average value of luminescence efficiencies of the second white-light LEDs 30 is V2, which is larger than that of the first white-light LEDs 20. In other words, V2 is larger than V1 (V2>V1). An average value of color rendering indexes of the second white-light LEDs 30 is C2, which is smaller than that of the first white-light LEDs 20. In words, C2 is smaller than C1 (C2<C1).

In this embodiment, a number of the first white-light LEDs 20 is less than that of the second white-light LEDs 30, a power of the first white-light LEDs 20 in total is equal to that of the second white-light LEDs 30 in total. By such an arrangement of the LED illumination module 100, an illumination intensity at the central portion of the LED illumination module 100 is substantially equal to that at the periphery thereof, because the originally weaker intensity of light generated by the first white-light LEDs 20 at the central portion of the LED illumination module 100 is compensated by a part of light generated by the second whit-light LEDs 30 which is directed toward the central portion. Therefore, the illumination intensities at the central portion and the periphery of the LED illumination module 100 are balanced. A more uniform illumination is obtained by the LED illumination module 100.

It is well understood that the number of the first white-light LEDs 20 and the second white-light LEDs 30 can be changed to meet different requirements, as long as the power of the first white-light LEDs 20 is equal to that of the second white-light LEDs 30, V2>V1, C2<C1 and the illumination intensities of the central portion and the periphery of the LED illumination module 100 are substantially equal to each other.

In another embodiment, each first white-light LED 20 may include a blue chip, a red chip and a green chip. The first white light can be formed by a mixture of light emitted from the blue chip, the red chip and the green chip. In a further alternative embodiment, each first white-light LED 20 includes an ultraviolet chip and a plurality of phosphor particles consisting of red phosphor particles, green phosphor particles, and blue phosphor particles mixed together. The phosphor particles are deposited on the ultraviolet chip to surround the ultraviolet chip. Thus, the phosphor particles can be excited by ultraviolet light from the ultraviolet chip to emit red light, green light and blue light. The red light, the green light and the blue light are mixed together to form the first white light. In a still further alternative embodiment, each first white-light LED 20 includes a blue chip, a green chip and a plurality of red phosphor particles. The red phosphor particles surround the blue chip and the green chip. Thus, the red phosphor particles can be excited by blue light and green light from the blue and green chips to emit red light. The first white light can be formed by mixture of the red light and the residuary blue light and the green light.

Reference to FIGS, 2-3, an LED illumination module 200 in accordance with a second embodiment is shown. The LED illumination module 200 is similar to the LED illumination module 100 and includes a base 10a, a plurality of first white-light LEDs 20a, a plurality of second white-light LEDs 30a and an engaging member 13 integrally extending upwardly from a periphery edge of the base 10a. The first white-light LEDs 20a are spaced from each other and mounted on a central portion of a top surface 11 of the base 10a. The second white-light LEDs 30a are spaced from each other and mounted on a periphery of the top surface 11 and surround the first white-light LEDs 20a.

The engaging member 13 is extended upwardly above the top surface 11 of the base 10a. The engaging member 13 and the base 10a are made of one piece. A recess 131 is defined between the engaging member 13 and the base 10a to receive the first white-light LEDs 20a and the second white-light LEDs 30a in a bottom end thereof. The recess 131 is fursto-conical with a large top and a small bottom. In other words, a diameter of the recess 131 is increased from a bottom end near the base 10a to a top end away from the base 10a.

A plurality of reflectors 14 are formed on an inner surface 133 of the engaging member 13 defining the recess 131. The reflectors 14 reflect a part of light emitted from the second white-light LEDs 30a to a place above the first white-light LEDs 20a to increase an illumination intensity of a central portion of the LED illumination module 200 wherein the illumination intensity of the first white-light LEDs 20a is lower than that of the second white-light LEDs 30a. In this embodiment, each reflector 14 is a hemispheroidal protrusion, and the reflectors 14 are continuously formed on the inner surface 133.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED illumination module, comprising:
a base;
a plurality of first white-light LEDs mounted on a central portion of a top surface of the base; and
a plurality of second white-light LEDs mounted on a periphery of the top surface of the base and surrounding the first white-light LEDs;
wherein a power of the first white-light LEDs in total is equal to that of the second white-light LEDs in total, and an average value of luminescence efficiencies of the first white-light LEDs is less than that of the second white-light LEDs.

2. The LED illumination module of claim 1, wherein an average value of color rending indexes of the first white-light LEDs is larger than that of the second white-light LEDs.

3. The LED illumination module of claim 1, wherein an engaging member is formed on the top surface of the base and surrounds the first and second white-light LEDs.

4. The LED illumination module of claim 3, wherein a recess is defined between the engaging member and the base, and the first and second white-light LEDs are received in a bottom end of the recess.

5. The LED illumination module of claim 4, wherein a plurality of reflectors is formed on an inner surface of the engaging member defining the recess to reflect a part of light emitted from the second white-light LEDs to a central portion of the LED illumination module to be mixed with light emitted from the first white-light LEDs to balance illumination intensities of the central portion and a periphery of the LED illumination module.

6. The LED illumination module of claim 5, wherein each reflector is a hemispheroidal protrusion.

7. The LED illumination module of claim 6, wherein the reflectors are continuously formed on the inner surface of the engaging member.

8. The LED illumination module of claim 5, wherein a diameter of the recess is increased from a bottom end near to the base to a top end away from the base.
